(19) United States
(12) Patent Application Publication
(10) Pub. No.: US 2003/0214593 A1
(43) Pub. Date: Nov. 20, 2003

(54) Flash system for underwater photography with a digital camera

(76) Inventor: Yoshiyuki Takematsu, Tokyo (JP)

Correspondence Address: BEYER WEAVER & THOMAS LLP, P.O. BOX 778, BERKELEY, CA, 94704-0778, US

(21) Appl. No.: 10/424,653

(22) Filed: Apr. 25, 2003

(30) Foreign Application Priority Data
May 17, 2002 (JP) 2002-179181

(51) Int. Cl. H04N 5/335

(52) U.S. Cl. 348/275

(57) ABSTRACT

A flash system for underwater photography includes a housing for containing a camera which may be a digital camera, a flash unit externally attached to this housing for emitting flash light, a light sensor on the housing for sensing reflected light and outputting detection signals according to the sensed reflected light, and a control signal generator inside the housing. The control signal generator includes an input device for allowing a user to specify a selected light quantity to be emitted from the flash unit and also serves to generate and output signals to the flash unit according to the detection signals from the light sensor and also the light quantity selected through the input device.

### BACKGROUND OF THE INVENTION

This invention relates to an improved flash system for use when a digital camera is input inside a waterproof housing (hereinafter referred to simply as “housing”) for underwater photography and in particular for the control of flash and illumination lamps.

When a digital camera is used for underwater photography, it is usually put inside a commercially available housing. Digital cameras of both the single-lens reflex type and the compact non-single-lens reflex type are available and will be hereinafter together referred to as digital cameras, or simply as cameras. Although cameras of the latter type are currently more popularly used, those of the former type may be gaining popularity in the future.

Prior art apparatus for underwater photography using a digital camera had problems in the control of exposure by a flash lamp. For controlling the flash light for a non-digital single-lens reflex camera using a conventional film a method that is generally referred to as the TTL automatic control (or the TTL direct control) is employed whereby reflected flash light from the target object is passed through the lens, reflected by the film and received by a sensor disposed in front of the film so as to be converted into an electrical signal. The converted electrical signal is analyzed and a signal to stop the emission of the flash light is outputted when it is determined that a specified quantity of flash light has been emitted.

This method was practical because the reflectivity of the film surface is about 15-25% and is just right for determining the exposure and usable even in underwater photography. In the case of a film this method is usable even with some deviation in exposure in view in part of the allowable latitude.

Digital cameras, however, do not use a film. Instead, elements such as CMOS and CCD are used, and since these elements are black, their reflectivity is low and not appropriate for determining exposure and these elements cannot be used for a TTL automatic control.

For this reason, it has been a common practice to cause flash light of weak intensity to be emitted preliminarily and immediately before the main exposure, to measure the reflected light from the target object simultaneously through the lens and by means of a sensor and to determine the level of the main exposure to follow, depending on the measured level of the reflected light.

Since an adjustment is made such that the exposure will be proper above the ground, this method is not adequate in the case of underwater photography because light is attenuated differently in water from above water and also because the refractivity of light is also different in water. For example, reddish light does not reach as far inside water as bluish light. Thus, the calculated exposure based on the data received by the preliminary emission may not be right for the main exposure. As a result, overexposure at shorter distances and underexposure at larger distances are likely to result.

Differences in operation and spectroscopic characteristics of the light sensor must also be taken into consideration in the case of a digital camera. In view of the problems as described above, automatic flash lamps to be externally attached are used, but such flash lamps must be used farther away from the camera lens (say, at a distance of 30 cm-50 cm) in order to prevent the so-called marine-snow phenomenon which results when small particles floating near the lens reflect the flash light and appear white on the picture taken. If the flash lamps are set thus far away, their light-measurement sensitivity is adversely affected and a proper exposure may not be made. Another problem to consider is that such automatic flash lamps cannot be manually adjusted.

There are additional problems regarding automatic focusing. In underwater photography, there are usually more dark spots than above the ground. As a result, the automatic focusing function may operate slowly or may even fail to operate. In view of these problems, it has been known to provide a light source for illumination (not for exposure). Such a light source may comprise a high-intensity LED or a laser, and will be hereinafter referred to as “illumination lamp”. Such an illumination lamp may be provided not only to the camera housing but also to the externally attached flash unit (such as shown at 3 and 10 in FIG. 1). It is not good enough, however, to turn off these illumination lamps simultaneously as the flash light is emitted because the light from the illumination lamp may enter through the lens and be photographed.

As illustrated in lines A and B of FIG. 8, it takes a finite length of time from the moment when the camera shutter begins to open (“70”) until it is completely opened (“71”). With some variations taken into account, it is still some time later (“72”) that the so-called X-contact of the camera is switched on and an electric signal is outputted to indicate the opening of the shutter. This delay may be about 3 milliseconds, although it depends on the type of the camera.

Even if the illumination lamps are extinguished simultaneously as the X-contact is switched on (“73”), the light from the illumination lamp will be entering the camera for the length of time indicated by numeral 74 in FIG. 8. The length of time of this unwanted exposure is actually longer because the emission of light from the illumination lamp does not stop instantly as the current therethrough is shut off. It depends on various factors such as the brightness of the target object, the lens opening and the shutter speed. It happens more significantly when the target object is dark and the shutter speed is slow.

### SUMMARY OF THE INVENTION

It is therefore an object of this invention to provide an apparatus with which good underwater photographs can be taken with right exposures by means of a digital camera inside a housing and by using flash units.

It is another object of the invention to prevent light of the illumination lamp from entering the camera when the target object is dark.

A flash system embodying this invention for underwater photography by a digital camera, with which the above and other objects can be accomplished may be generally characterized as comprising a housing for the camera, a flash unit for emitting flash light externally attached to the housing, a light sensor on the housing for sensing reflected light and outputting detection signals according to the reflected light sensed thereby, and a control signal generator which is inside the housing, includes an input device for allowing a user to specify a selected light quantity to be emitted from the flash unit, and generates and outputs signals to the flash unit according to the detection signals from the light sensor and the selected light quantity. The housing may be divided into a main housing body and a box that is disposed adjacent and electrically connected to the main housing body such that at least a portion of the control signal generator is contained inside the box. The input device may be set either on the box or on an outer surface of the main housing body.

An flash system of this invention may be characterized alternatively as comprising a housing for containing the camera, a flash unit externally attached to the housing for emitting flash light, an illumination lamp, a control signal generator inside the housing for generating and outputting signals to the flash unit according to the detection signals from the light sensor and the selected light quantity, and a lamp controller for switching off the illumination lamp by using as trigger a fully-pressed signal that is outputted when the shutter button of the camera is fully pressed.

As another alternative, it may be characterized as comprising a housing for containing the camera, a flash unit externally attached to the housing for emitting flash light, an illumination lamp on the flash unit, and a lamp controller for switching off the illumination lamp by using as trigger a short pulse signal received from the housing, the short pulse being about 5 microseconds in duration and significantly shorter than the duration of the flash light.

As a further alternative, it may be characterized as comprising a housing for containing the camera, a flash unit externally attached to said housing for emitting flash light, an illumination lamp, and a lamp controller for switching off the illumination lamp, a portion of the lamp controller inside the housing generating a significantly shorter control pulse signal than the duration of the flash light for the illumination lamp.

### BRIEF DESCRIPTION OF THE DRAWINGS

FIG. 1 is a front view of an example of flash system embodying this invention.

FIG. 2 is a front view of the housing of the flash system shown in FIG. 1.

FIG. 3 is a partially sectional view of the housing of FIG. 1.

FIG. 4 is a back view of the housing of FIG. 1.

FIG. 5 is a circuit diagram of a portion of the control signal generator on the side of the housing.

FIG. 6 is a circuit diagram of the housing shown in part as a block diagram.

FIG. 7 is a circuit diagram of another housing.

FIG. 8 is a timing chart for showing the operations of parts of the flash system of this invention inclusive of timing charts of a prior art operation for comparison.

FIG. 9 is circuit diagram of an externally attached flash unit embodying this invention shown in part as a block diagram.

FIG. 10 is a circuit diagram of a portion of the externally attached flash unit of FIG. 9.

FIG. 11 is a back view of another housing embodying this invention for a flash system.

### DETAILED DESCRIPTION OF THE INVENTION

The invention is applicable to digital cameras of both the single-lens reflex type and the compact non-single-lens reflex type, although it will be described below only for the case of the former type.

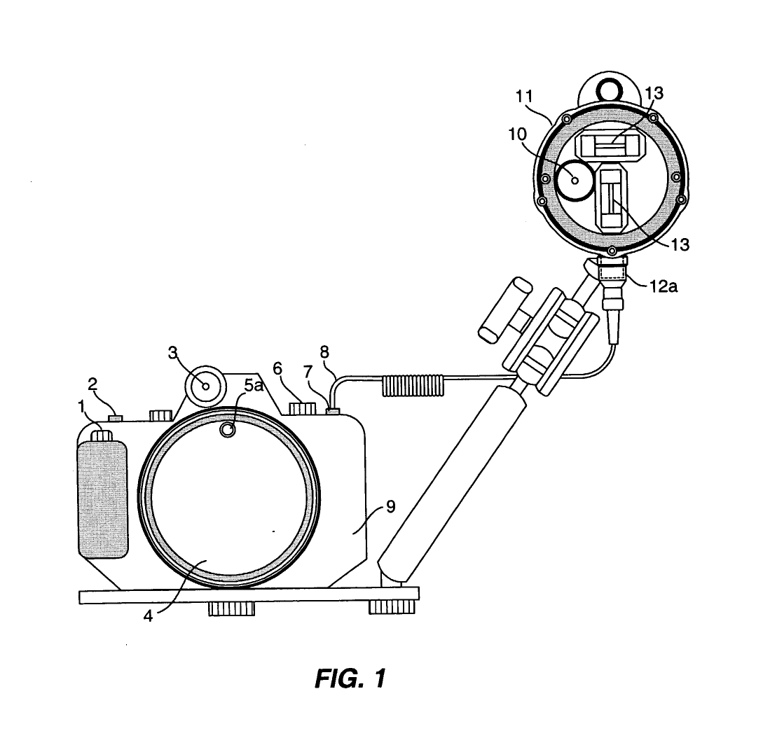

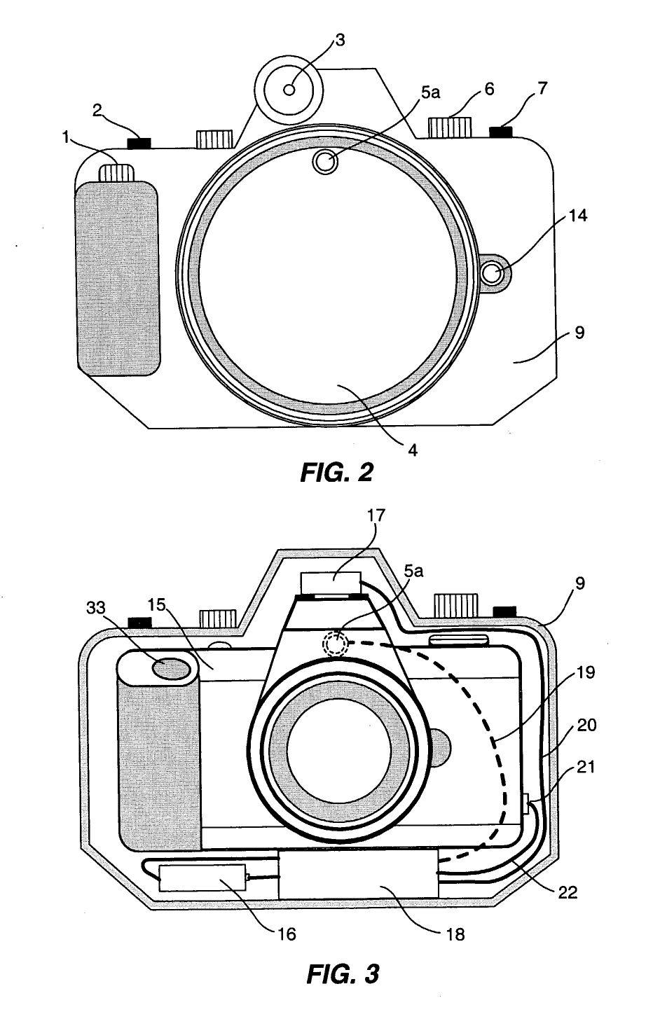

FIG. 1 is a front view of a flash system embodying this invention, including a housing 9 with a camera inside, and FIG. 2 is a front view of the housing 9. FIG. 3 is a sectional view of the housing 9 with a camera 15 inside. The housing 9 is of a waterproof structure and contains not only the camera 15 but also a battery 16 as a power source and a device unit 18 including various devices. On the exterior of the housing 9 are a shutter button 33 of the camera 15, a front plate 4 made of a glass or acryl material, an illumination lamp 3, an operation button 6 and two light signal outputting terminals 2 and 7.

FIG. 1 shows a situation wherein only one of these light signal outputting terminals (7) is connected to a light sensor 12a of an externally attached flash unit 11 through an optical fiber cable 8. The optical fiber cable 8 of FIG. 1 may be replaced by a more commonly used type of lead line. Such connections are well known and hence no further detailed explanation will be presented. If the connection is by means of such a lead line, there is no need to convert the electrical signal from the camera into an optical signal and optical signal back to another electrical signal but the connector and the lead line must be waterproofed.

The flash unit 11 is provided with a light bulb (“illumination lamp”) 10 and discharge tubes 13 in front. As one of the features of this invention, there is a flash light receiving sensor 5a attached to the aforementioned front plate 4. This sensor 5a itself may be formed by inserting a photoelectric converter element such as a phototransistor into a waterproof light-screening tube. The attachment may be made without forming any hole through the front plate 4 from the backside towards the front or forming a hole and attaching the sensor 5a in the forward direction. If the attachment to the glass or acryl material of the front plate 4, the supporting member therefor, usually made of aluminum, may be provided with a broadened edge portion for attaching the sensor 5a.

FIG. 2 shows an example, for the purpose of illustration, provided with another attachment 14 for the sensor 5a. As the direction of the sensor may be adjusted to the direction towards the center of the lens, it is convenient for accurately measuring the quantity of exposed light when a target object at an extremely short distance is being photographed.

The position of attachment is not limited to the places indicated in FIG. 2. When the connecting wires are externally exposed, however, care must be taken to waterproof such wiring. As another example, an optical fiber may be used as a part of the sensor 5a. In such a case, the main part of the sensor 5a may be at any position. One end of the optical fiber is connected to the main body and the other end is oriented in the same direction as the axis of the lens, such that the direction of incident light will be the same as that into the lens. In the case of a sensor of this type, the position of the light-receiving end of the optical fiber will be regarded as the position of the sensor 5a. Although both symbols 5a and 14 in FIG. 2 indicate an optical sensor, it is not intended to mean that there should be two sensors.

The conventional type of TTL automatic control is disadvantageous because it is not the reflected light from the target object that is directly measured. Since the reflectivity of the film surface is not uniform but varies according to the type and the maker of the film, the conventional TTL control introduces variations in exposure. The present invention has the merit of reducing such variations in exposure because reflected light from the target object to be photographed is directly measured.

The device unit 18 placed below the camera 15 below the battery 16 as shown in FIG. 3 includes a control signal generator which is a part of what is herein referred to as the light quantity controller for the externally attached flash unit 11. The device unit 18 is connected to the shutter remote (cable release) terminal 21 of the camera 15 through line 22 to a connector (common referred to as the “hot shoe” 17) through line 20 and to the aforementioned flash light receiving sensor Sas through line 19.

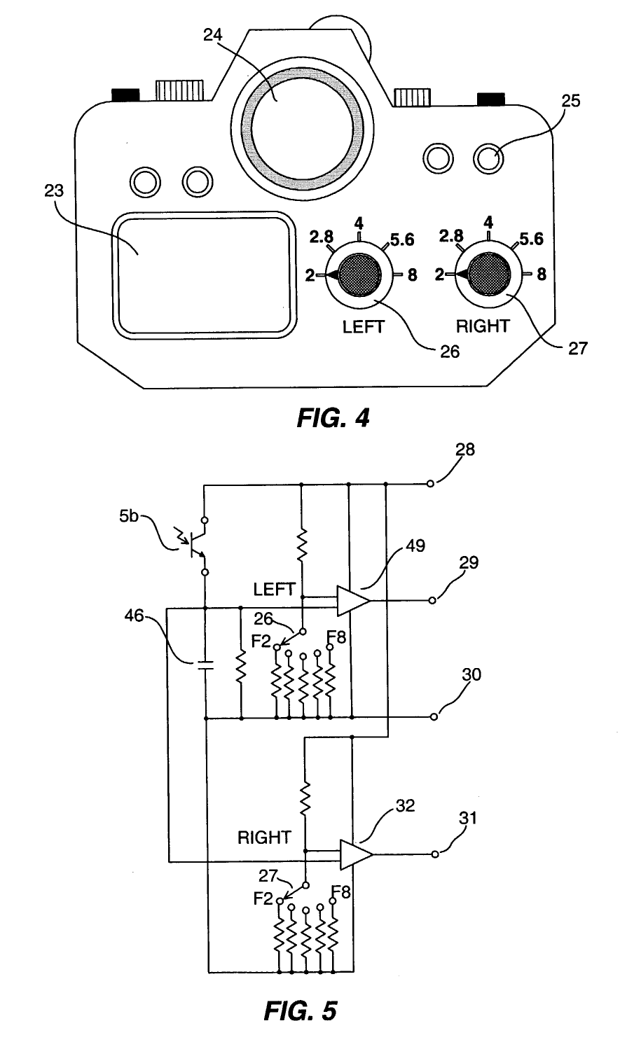

As shown in FIG. 4, the back side of the housing 9 contains a liquid crystal display device 23, a finder 24, an operating button 25, light quantity setting switches 26 and 27 respectively for adjusting the quantity of flash light emitted from the left-hand and right-hand side flash unit. It is to be reminded that only one flash unit 11 is shown in FIG. 1 but it is preferable to use two flash units respectively connected through the two light signal outputting terminals 2 and 7. By independently controlling the two light quantity setting switches 26 and 27, three-dimensional (that is, not flat) photographs can be taken by varying the balance of the light quantities from the two flash units on both sides of the camera 15. These switches 26 and 27 need not necessarily be provided on the backside of the housing 9. If space is available, they may be positioned on a side surface or on the top surface.

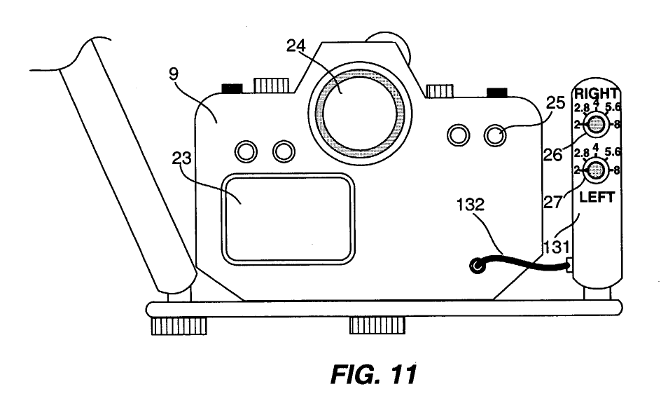

The aforementioned control signal generator need not be inside the housing 9. Since it has many components, a small box (sometimes referred to as the “grip”) 131 as shown in FIG. 11 may be provided adjacent to the housing 9 to contain some or all of the components of the control signal generator. The housing 9 and the grip 131 are connected by a lead line 132 which must be water proofed. Alternatively, the housing 9 and the grip 131 may be connected by a tubular connector and may be formed integrally with the connecting lead line disposed inside. The flash unit 11 may be directly attached to the grip 131.

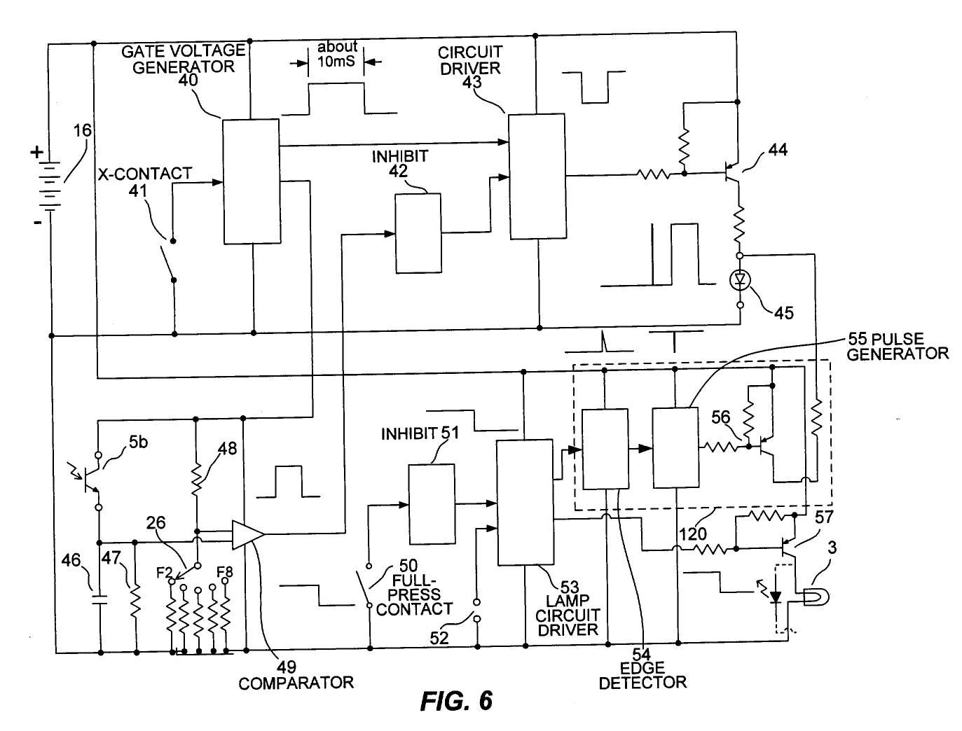

The electrical system includes an illuminating lamp control circuit and the aforementioned light quantity controller for the flash unit (or units). The light quantity controller includes signal transmitting means on the side of the housing and signal receiving means on the flash unit. FIG. 6 shows the circuit structure of the device unit 18 on the side of the housing 9 (or of the interior of the grip 131), including the control signal generator as a part of the light quantity controller, a light-off signal generator 120 for the illumination lamp 3 and a lamp control device for the illumination lamp 3. In FIG. 6, numerals 50, 51, 52 and 53 are common to both the light-off signal generator and the lamp control device for the lamp 3, numeral 57 is a part of the lamp control device and all the others are the control signal generator. The LED 45 and the battery 16 are used in common.

The illuminating lamp control circuit serves to extinguish the illuminating lamps 3 and 10 when the camera shutter is fully pressed. Camera shutters are usually pressed in two stages. When a camera shutter is half pressed, or pressed to a half-way position, a “half pressed signal” is outputted. When it is pressed all the way down to its full extent, a “fully pressed signal” is outputted. According to the present invention, the illuminating lamps 3 and 10 are extinguished by using the fully pressed signal as its trigger signal because, as explained above, it is not early enough to extinguish the lamps 3 and 10 as the flash unit begins to emit flash light.

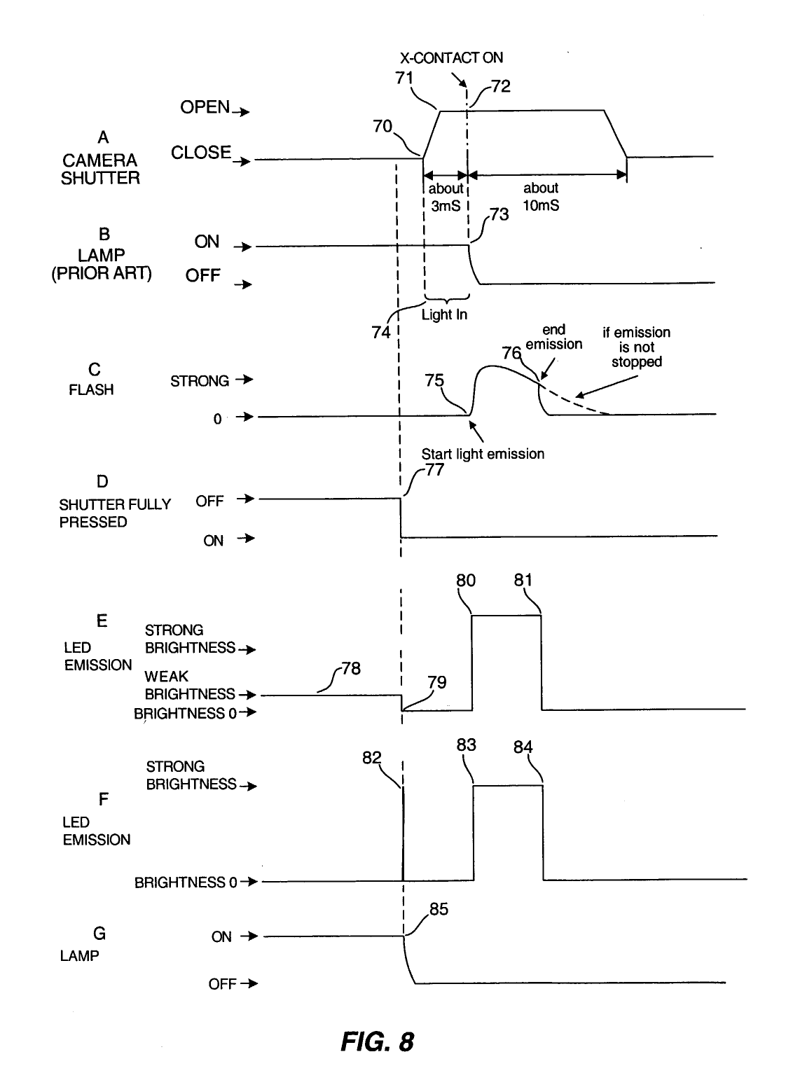

As shown at 77 in FIG. 8, a fully pressed signal is generated when the camera shutter is fully pressed. As explained above, the shutter begins to open somewhat later at 70 and becomes completely open at a still later time (at 71) and the X-contact is switched on at a further later time (at 72). According to this invention, the fully pressed signal 77 triggers the extinction of the illumination lamps 3 and 10 as shown at 85. Although it takes a finite length of time for the illumination lamps 3 and 10 to become completely dark, this finite length of time is much shorter than the time for completely opening the shutter (at 71). Thus, the light from the illumination lamp 3 is reliably prevented from entering the camera to be photographed.

The aforementioned fully pressed signal 77 may be obtained from the shutter remote terminal 21 of the camera 15. Almost every single-lens reflex camera has a shutter remote terminal, to be used with a release cable having a long cord to be attached thereto for opening the shutter from a distant position. The shutter remote terminal 21 is connected in parallel with the shutter button 33 of the camera 15 such that the aforementioned fully pressed signal 77 is outputted also from the shutter remote terminal 21 as the shutter button 33 of the camera 15 is fully pressed.

The illumination lamps 3 and 10 are switched on by pressing down the shutter button 33 half-way so as to switch on the camera circuit and too detect a signal indicative thereof. Such a signal may be detected at a terminal in the hot shoe 17, at a detection terminal 52 shown in FIG. 6 as the “system voltage” or at the shutter remote terminal 21.

With reference to FIG. 6, as a signal is inputted from the system voltage detection terminal 52 to a lamp circuit driver 53, transistor 57 is switched on and the illumination lamp 3 becomes lit. As the shutter 33 is fully pressed and a full-press contact 50 is switched on, this signal is used as a trigger by an inhibit circuit 51 to switch off the lamp circuit driver 53. This causes the transistor 57 to be switched off, and the illumination lamp 3 is extinguished. Thus, the light from the illumination lamp 3 does not enter the camera.

Next, the operation of the light-off signal generator 120 is explained. As the lamp circuit driver 53 is switched off, as explained above, an edge detector circuit 54 of a known type detects the sudden change (or edge) of the fully pressed signal 77 and transmits a detection signal to a pulse generator circuit 55 of also a known type. The pulse generator circuit 55 generates in response a short pulse of duration about 5 microseconds as shown at 82 in FIG. 8 and transmits it to a transistor 56, thereby causing a signal light to be emitted from a signal-light emitting LED 45 and transmitted through the optical fiber cable 8 to the light sensor 12a of the flash unit 11 (as shown in FIG. 1) so as to be converted into various control signals by the circuits inside the flash unit 11 to control its illumination lamp 10. If the output of the edge detector circuit 54 can be adjusted to about 5 microseconds, the pulse generator circuit 55 may be dispensed with.

Since this signal light from the signal-light emitting LED 45 is only for the purpose of being controllable by the flash unit 11, its width need not be exactly 5 microseconds but may be as short as 2 microseconds or as long as 8 microseconds. What is essential is that it should be significantly shorter than the duration of the flash light from the discharge tubes 13 of the flash unit II but the flash light from the discharge tubes 13 is never as short as 5 microseconds and lasts usually longer than 10 microseconds. In what follows, the expression “short pulse” is used in this limited sense.

It is one of the distinguishing characteristics of the present invention to control the illuminating lamp of an externally attached flash unit by means of a pulse signal of such a short duration. According to the conventional technology, a weaker signal as shown at 78 of FIG. 8 was used and hence an amplifier circuit was required. Thus, one of the advantages of the present invention is that such an amplifier circuit can be dispensed with and another advantage is that energy is not wasted because the signal light emitting LED 45 is not caused to continuously emit light. It is to be noted, however, that the signal for emitting illumination light from the flash unit is not outputted from the camera. It is only the signal to stop its emission. In order to switch on the illumination light from the flash unit, a timer switch on the flash unit must be switched on.

Although this method of the invention can be applied not only to digital cameras of the single-lens reflex type but also to non-single-lens reflex type cameras, there are many non-single-lens reflex type cameras that are not capable of detecting the fully pressed condition of the shutter. In such a situation, use may be made, as a trigger for the extinction of the illumination lamp, of the light signal from an LED which switches on when the automatic focusing has been successfully completed after the shutter button has been half pressed, or of the light signal emitted when the internally set flash lamp undergoes a preliminary emission. Since such detections can be made by conventionally known methods with conventionally available devices, explanations thereof will be herein omitted.

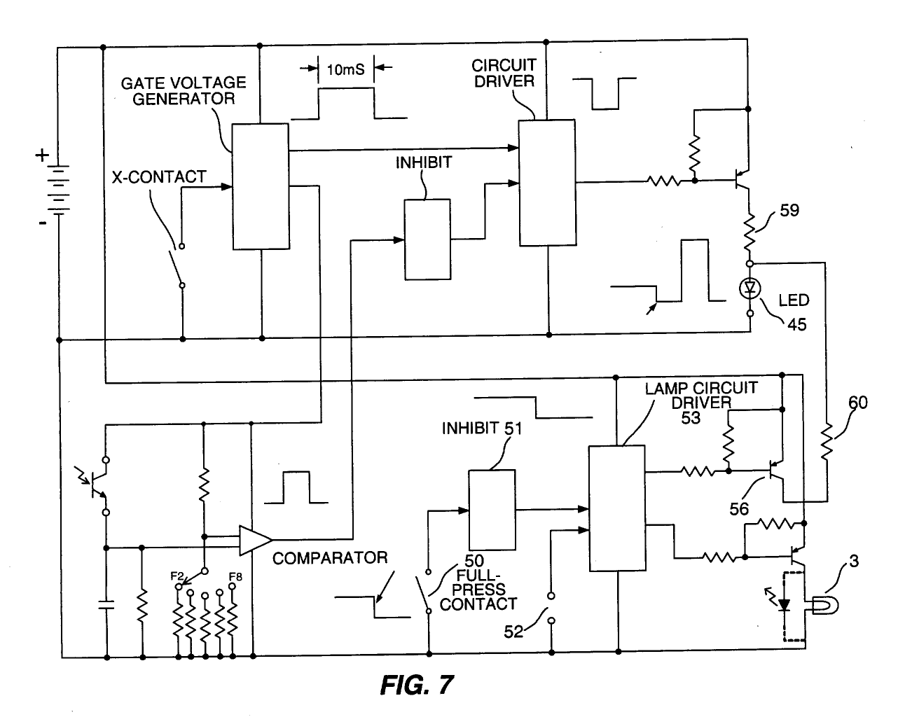

FIG. 7 shows another circuit structure in part incorporating prior art technology, that is, it is different from the structure shown in and explained above with reference to FIG. 6 in that the edge detector circuit 54 and the pulse generator circuit 55 are removed and that the signals from the system voltage detection terminal 52 and the fully pressed contact 50 are used in combination. As shown in FIG. 7, a higher resistor 60 with higher resistance is connected to the transistor 56 than the lower resistor 59 with lower resistance such that the brightness of the signal light from the LED 45 is reduced and hence becomes distinguishable from that of the stronger flash light.

In FIG. 8, these signals are indicated by numerals 78 and 79. In other words, the flash unit 11 distinguishes between the weaker and stronger emissions to control the illumination lamp 10 and the discharge tubes 13. This can be carried out by means of a voltage detector of a known type.

Next, the flash operating mechanism, that functions after the illumination lamps 3 and 10 are switched off, will be explained with reference to FIG. 6. This mechanism includes not only the externally attached flash unit 11 but also the aforementioned light quantity controller. FIG. 6 shows the device unit 18 but its components may be contained either in the housing 9 or the grip 131 and includes the aforementioned control signal generator. It is to be noted that FIG. 6 shows only important components. Less important and/or commonly known portions are largely omitted.

Operations of the flash operating mechanism are explained next sequentially. Broadly explained, the functions of this mechanism on the side of the housing are to transmit signals for starting and stopping emission of the flash light and those on the side of the flash unit are to receive these signals and too accordingly start and stop the emission of flash light.

After the shutter button of the camera is fully pressed, the X-contact 41 of the camera is switched on at the timing indicated by numeral 72 as shown in FIG. 8 and a pulse signal of about 10 milliseconds is generated by a fate voltage generator circuit 40 and applied to a circuit driver 43, a flash light sensor 5b and a comparator 49. As the circuit driver 43 causes transistor 44 to be switched on, the signal-light emitting LED 45 begins to emit light as shown by numeral 80 or 83 in FIG. 8. The discharge tubes 13 of the flash unit 11 begin to emit light as shown at 75 by receiving this signal although the optical fiber cable 8.

The operations of the control signal generator are as follows after the emission of flash light is started. As the flash light emitted from the flash unit 11 is reflected by a target object, the reflected light received b y the flash light sensor 5a is converted into electrical signals and integrated by an integration circuit 46 with a resistor 47 for discharge. The resultant voltage of the integration is compared by means of a comparator 49. When the voltage defined by a comparator resistor 48 and the light quantity setting switch 26 reaches a specified level, a stop signal (usually a Lo signal) is outputted from the comparator 49. The timing of the emission of this signal is determined according to the desired level of exposure set on the camera. In other words, the stop signal is outputted such that the desired level of exposure is accomplished if the emission of the flash light is stopped in response to this signal. Although an example with an integration circuit was illustrated, this may be replaced, for example, by a calculating device comprising a microcomputer (CPU) with a digital circuit.

For the sake of simplicity, description was given above only for one flash unit. Where two flash units are connected to the camera to be controlled by two independently operable light quantity setting switches 26 and 27, as shown in FIG. 4, two comparators 49 and 32 are provided as shown in FIG. 5 corresponding thereto. In FIG. 5, terminal 28 is connected to the gate voltage generator circuit 40, terminal 29 is connected to an inhibit circuit 42 and terminal 30 is connected to the negative terminal of the battery 16. The output terminal 31 of the other comparator 32 is connected to another inhibit circuit (not shown). In other words, another set of circuits equivalent to that including inhibit, circuit driver, transistor and LED 42, 43, 44 and 45 is required, although not shown in FIG. 6 or 7 for convenience. The flash light sensor 5b and the integration circuit 46, however, may be shared by both flash units for reducing cost.

When an end signal {usually a Hi signal) is outputted from the comparator 49, the inhibit circuit 42 switches off the circuit driver 43 and hence the transistor 44, causing to terminate the emission of the strong light from the signal-light emitting LED 45 as shown at 81 or 84 in FIG. 8. This represents the intended optimum exposure by the flash light.

As the light from the LED 45 stops, the flash unit 11 stops the emission of flash light, as shown by numeral 76 in FIG. 8.

As explained above, the externally attached flash unit 11 includes a part of what is herein referred to as the light quantity controller, functioning by receiving and in response to the signals from the control signal generator and the light-off signal generator for the illumination lamp.

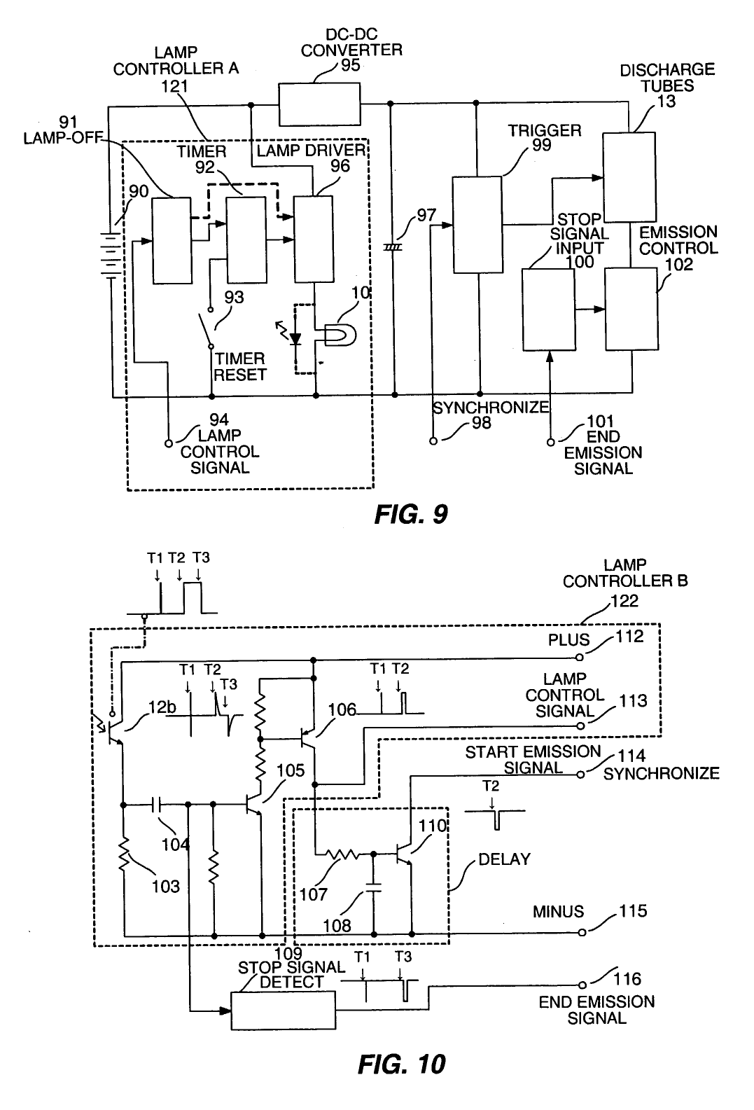

FIG. 9 is a block diagram of the flash unit 11 and FIG. 10 shows the circuit structure of its sensor circuit and its signal detection circuit. These circuits are connected through lead lines to the circuit shown in FIG. 9, having a plus terminal 112 connected to the positive terminal of a battery 90 and a minus terminal 115 connected to its negative terminal.

The portion of the circuit shown in FIG. 10 excluding lamp controllers 121 and 122 is for the flash light and includes a portion of the light quantity controller. A portion of the circuit shown in FIG. 10 is also used for the control of the illumination lamp 10. Some of the portions not related to this invention are omitted from FIG. 10 for clarity Of the two methods of controlling the illumination lamp described above, the one by means of a short pulse explained above by way of FIG. 6 and numeral 82 of FIG. 8 will be explained for the control of the illumination lamp 10 of the flash unit 11. The other method explained above by way of numerals 78, 79, 80 and 81 is well known and is carried out by distinguishing between stronger and weaker light from the LED.

As a detection signal from the LED 45 is received through the optical fiber cable 8 by the light sensor 12a of the flash unit 11, it is converted into an electrical signal and its waveform is changed by a DC-cutting capacitor 104 which also serves as a differentiator. In FIG. 10, numeral 103 indicates the load resistance of the light sensor 12a.

As the signal, with its waveform thus converted, is amplified by transistors 105 and 106, only signals T1 and T2 are outputted on the positive side as the lamp control signal through terminal 113 and a lamp control signal input terminal 94 shown in FIG. 9 to a lamp-off circuit 91. The lamp-off circuit 91 is provided with a timer function of a known kind, serving to inactivate a timer circuit 92 for a specified length of time such as one second so as to switch off a lamp driver circuit 96 and to switch off the lamp 10 for one second.

The lamp-off circuit 91 is also capable of keeping the lamp 10 switched off for a longer period of time by keeping the timer circuit 92 in an inactive condition by a circuit method of operation until a timer reset 93 is switched on.

When the lamp 10 is kept switched on for an extended period of time, the timer circuit 92 is not required. In such a situation, the lamp-off circuit 91 can control the lamp driver circuit 96 directly as indicated by dotted line in FIG. 9 to switch off the lamp 10.

In any of the above situations, the lamp 10 is switched off as shown at 85 in FIG. 8 and the light therefrom is prevented from entering the camera. Each of the cycles described above is initially activated by signal T1 but there is no problem if it was at the time of T2 because the lamp 10 already switched off by this time.

A same signal as the lamp control signal is inputted from the transistor 106 to a delay circuit 111 comprising a resistor 107 and a capacitor 108. This functions as an integration circuit for a short period of time and may also be referred to as a low pass filter, serving not to pass short signals (of about 5 microseconds) such as TI but to pass longer signals, say, longer than 10 microseconds. Such a low pass filter characteristic can be achieved by properly selecting the values of its resistor 107 and capacitor 108. It is not preferable to make the delay time too long because the start of the light emission is excessively delayed. The output from the transistor 106 becomes T2 alone and the lamp control signal is cut.

As the emission start signal is transmitted from the synchronization terminal 114 (98) to activate a trigger circuit 99, the discharge tubes 12 begin to emit flash light as shown by numeral 75 in FIG. 8. The flash unit has a high-voltage charge preliminarily prepared by a DC-DC converter circuit 95 and saved in a main capacitor 97 so as to be ready for the discharge and the emission of flash light.

The DC-cutting capacitor 104 is also connected to a stop signal detector circuit 109 which has a similar circuit structure as the transistor 105 and serves to detect an emission stop signal T3. When signal T1 is received by the stop signal detector circuit 109, this has no consequence because this is before the emission of light from the discharge tubes 13 is started. The emission stop signal T3 is inputted through terminals 116 and 101 to a stop signal input circuit 100, causing a light emission control circuit 102 to switch off the current to the discharge tubes 13 and switching them off as shown by numeral 76 in FIG. 8. This completes one cycle of operations. An IGBT element of a known type may be used as the light emission control circuit 102. The method of using it is also well known.

The invention has been described in terms of only a limited number of examples but they are not intended to limit the scope of the invention. Many modifications and variations are possible within the scope of the invention. Such modifications and variations that may be apparent to a skilled person in the art are intended to be included within the scope of the invention.

What is claimed is:

1. A flash system for underwater photography by a digital camera, said flash system comprising:
a housing for containing said camera;
a flash unit externally attached to said housing for emitting flash light;
a light sensor on said housing for sensing reflected light and outputting detection signals according to sensed reflected light;
a control signal generator inside said housing including an input device for allowing a user to specify a selected light quantity to be emitted from said flash unit, said control signal generator generating and outputting signals to said flash unit according to said detection signals from said light sensor and said selected light quantity.

2. The flash system of claim 1 wherein said housing includes a main housing body and a box that is disposed adjacent and electrically connected to said main housing body, at least a portion of said control signal generator is contained inside said box.

3. The flash system of claim 2 wherein said input device is on said box.

4. The flash system of claim 2 wherein said input device is on said main housing body.

5. The flash system of claim 1 wherein said control signal generator is one of a plurality of control signal generators which are independently controllable.

6. The flash system of claim 2 wherein said control signal generator is one of a plurality of control signal generators which are independently controllable.

7. An flash system for underwater photography by a digital camera, said flash system comprising:
a housing for containing said camera, said camera having a shutter button for opening a shutter and outputting a fully-pressed signal when said shutter button is fully pressed;
a flash unit externally attached to said housing for emitting flash light;
an illumination lamp;
a control signal generator inside said housing for generating and outputting signals to said flash unit according to said detection signals from said light sensor and said selected light quantity; and
a lamp controller for switching off said illumination lamp by using said fully-pressed signal as trigger.

8. The flash system of claim 7 wherein said illumination lamp is on said housing.

9. The flash system of claim 7 wherein said illumination lamp is on said flash unit.

10. The flash system of claim 7 wherein said illumination lamp is one of two illumination lamps, one of said two illumination lamps being on said housing and the other thereof being on said flash unit.

11. An flash system for underwater photography by a digital camera, said flash system comprising:
a housing for containing said camera;
a flash unit externally attached to said housing for emitting flash light;
an illumination lamp on said flash unit; and
a lamp controller for switching off said illumination lamp by using as trigger a short pulse signal received from said housing, said short pulse being significantly shorter than the duration of said flash light.

12. An flash system for underwater photography by a digital camera, said flash system comprising:
a housing for containing said camera;
a flash unit externally attached to said housing for emitting flash light;
an illumination lamp; and
a lamp controller for switching off said illumination lamp, said lamp controller having a portion inside said housing, said portion generating a short control pulse signal for said illumination lamp, said short pulse being significantly shorter than the duration of said flash light.
